(19) United States
(12) Patent Application Publication
(10) Pub. No.: US 2006/0243256 A1
(43) Pub. Date: Nov. 2, 2006

(54) Surface reactor

(76) Inventor: Wolfgang Hornig, Monaco (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/511,067

(22) PCT Filed: Apr. 14, 2003
(86) PCT No.: PCT/DE03/01247

§ 371 Date: Jul. 5, 2006

(30) Foreign Application Priority Data
Apr. 12, 2002 (DE) 102 16 462.2

(51) Int. Cl. F02B 51/00; C10G 35/00; B21D 51/16

(52) U.S. Cl. 123/536; 208/133; 29/890

(57) ABSTRACT

A surface reactor includes a copper-tin alloy for converting unsaturated hydrocarbons contained in propellants and fuels. The surface reactor is configured in one-piece from a long chip or wire-shaped body. The surface reactor is configured from the alloy or from a support material that has been appropriately shaped and coated with the alloy.

The present invention relates to a surface reactor for improving liquid or gaseous fuel, including a body that is at least partially made of an alloy containing at least 80% tin, and the alloy constituting an active material that reacts with the fuel.

### BACKGROUND

Tin-alloy based reactors of this type are known from German Patent Applications DE 196 19 454 A1 and DE 198 29 174 A1. The granules described agglomerate while the fuels flow therethrough. Consequently, the surface area required for an adequate reaction is no longer available.

German Patent Application DE 199 44 227 A1 proposes to prevent agglomeration by producing a cast sponge structure. The sponge structure does not produce the desired effect because the sponge body casting process does not guarantee optimum surface action either. During the casting process described in German Patent Application DE 199 44 227 A1 for producing a sponge body, the sponge body becomes covered with the pyrolysis residues that form as the plastic sponge fully cures. Thus, the fuel does, in fact, flow over a large surface area; however, the large surface area is not effective because it is densely covered with plastic residues and pyrolytic coke.

German Patent Application DE 42 13 808 A1 describes a reactor formed by a ceramic honeycomb coated with alloy material. For storage in a housing, the ceramic honeycomb is covered with a stainless steel mesh which, together with the honeycomb, is dipped into the alloy bath and subsequently pressed into the housing.

British Patent Application GB 2 317 921 A describes different ways to equip a fuel system with catalysts. One of these options is to coat the catalyst material onto a mesh of steel or other suitable material.

### SUMMARY OF THE INVENTION

It is an object of the present invention to design a surface reactor in a manner that guarantees a uniform and clog-proof pressure distribution with little flow resistance in the reactor housing over a long period of time and allows the surface reactor to be adapted to any reactor housing shape.

This objective is achieved in accordance with the present invention in that the body is exclusively composed of the alloy, or is made of a support material coated with the alloy, and in that the body is as a band, chip, spiral or wire in the shape of a filament; the ratio of the length to the average diameter of the body being a value between 10 and 10⁸, in particular 2*10⁵.

Thus, the surface reactor is not produced using a thermal process including pyrolysis of plastic, but formed of a single, very long chip of an active material containing tin and copper as the main components as well as silver and gold or platinum as additional components. Thus, the active body is only composed of a substantially continuous body, which can be formed or deformed according to the reaction chamber. The filamentous, inherently resilient wad does not agglomerate together, thus preventing an unfavorable pressure distribution from developing inside the reaction chamber during use, which would lead to clogging.

In this manner, the geometric arrangement established after installing the body is prevented from changing during use. When using a filamentous body, there is no shift in the network structure. When using a plurality of bodies, relative movement occurs between the bodies; the relative movement being negligible in view of the advantageous property of the filaments. However, the number of bodies should be kept low in view of this advantageous property of the present invention.

When the fuel flows through the entangled or interwoven body, the copper-tin alloy reacts with the fuel, converting unsaturated hydrocarbons in low concentration into organotins. During combustion, the organotins can be ignited very easily, and therefore act as ignition nuclei in the combustion chamber.

Thus, even slow-burning fuels, such as rapeseed oil or oilified plastics or waste materials, can be burned with only a small quantities of conventional fuels added, while at the same time achieving excellent emission levels and exhaust-gas volumes. The improvement in efficiency of the reactor, which is also achieved by this filamentous structure, makes it possible to achieve an emission reduction as will be required, for example, throughout the European Union in the coming years.

The exhaust gas stream optimally enriched with catalysts in this manner results in an improved reduction of emission levels by the exhaust catalyst.

The surface reactor according to the present invention allows a stream of motor fuel or heating oil to be enriched with organotins over a period of more than 2000 operating hours in such a manner that the combustion behavior is permanently and significantly improved by the action of the ignition nuclei and the oxide catalysts resulting therefrom.

In this connection, moreover, it is advantageous for the body to be made of a support material at least coated with the alloy, or to be exclusively composed of the alloy. From a certain size of the body on, a coated support material is advantageous because the surface to be coated can be increased depending on the material used as the support material; i.e., the specific amount of surface area per unit area can be adjusted prior to coating.

In case of very filigreed bodies, a chip or filament made directly from the alloy provides an optimum solution. The starting material used for this purpose is a cast cylinder which is uniformly machined on a lathe with a special cutting tool producing a so-called “continuous chip” until the length of the chip has reached the mass for an active body. Depending on the body size and the chip thickness, these lengths range from about 10 to 100 meters.

In accordance with a further refinement, another possibility is to form the support material or the body as a chip with an average thickness of 0.1-0.9 mm, in particular 0.5 mm, and an average width of 1 to 15 mm, in particular, 5 mm. In the case of the chip removal process, the material must be cast into the shape of a cylinder free of cavities so that it can be machined into a continuous chip without breaking. This is the case for a size of 0.1-0.9 mm in thickness and 2-5 mm in width. The required flexibility and inherent resilience in the body are guaranteed by an adequate diameter or thickness. Moreover, the specific surface area per unit mass of material can be optimized by the thickness or width.

It is also advantageous for the support material or the body to be formed into the shape of a band, spiral or wire having an average diameter of 1-30 mm, in particular 10 mm, using a mechanical cold or hot forming process. Thus, the body is not produced in a relatively complex machining process, but, for example, drawn as wire.

It is also advantageous for the body to be braided, woven, twisted or interwoven in order to increase the surface area. In this manner, the specific surface area per unit volume of the reaction chamber is increased, i.e., adjusted. The body can first be braided or twisted as a rope, and then be stuffed into the reaction chamber like a wad.

Finally, a preferred embodiment of the design approach of the present invention proposes that the body formed as a band be at least partially rolled, punched and/or stamped in order to increase the surface area. The specific surface area per unit area can be increased in this manner.

It is of particular importance to the present invention that the alloy be applied to the support structure surface in the form of a coating, and that the support material be made of metal, of organic and/or inorganic materials, such as plastic or ceramic. This allows adjustment of the alloy mass, and thus of the service life of the body. The support materials used do not react with the alloy material and prevent the formation of alloy slurry, which could lead to clogging or unfavorable pressure distributions.

In connection with the design and arrangement according to the present invention, it is advantageous for the support material to be electrically conductive. The electrical conductivity simplifies the deposition of the alloy. Plastic and ceramic materials can be made electrically conductive by applying conductive lacquers, such as conductive silver, or by mixing electrically conductive particles into the base material.

It is also advantageous for the alloy to be applied to the support material by electrolysis, vapor-deposition, cold spraying, spraying, or dipping. Due to the variety of possible support materials, there are almost no limits to the coating method.

Moreover, it is advantageous for the body, in its braided, woven, twisted, or interwoven form, to be formed according to the shape of a reaction chamber, for example, in a cylindrical, spherical and/or cuboidal shape. The chip, wire mesh, punched sheet metal, or coated body so produced is inserted into the reaction chamber.

Furthermore, it is advantageous for the body to be inserted in fuel-carrying components, such as tanks, hoses, and/or filter housings. This allows the fuel to be processed without an additional reaction chamber. The reaction chambers are designed as housings and are able to rest freely in the fuel without inlets or outlets and with a permeable surface. In this connection, it is important that the alloy not contact other metallic objects, such as the wall of a fuel tank.

In order to limit the complexity of the surface reactor according to the present invention, it is advantageous to equip the reaction chamber with an inlet pipe and an outlet pipe, and to provide a filter at least on the outlet side directly before the outlet pipe downstream of the body. The filters in the form of metallic cloths, perforated plate or filter mats made of wire screen or fabric, are used for reliability reasons. If safety valves should be necessary, then such valves are also installed in the outlet. Advantageously, the housing forming the reaction chamber is screwed together to allow for replacement of the body or the filters.

Finally, it is advantageous to provide a spacer ring in the reaction chamber directly after the inlet pipe in the direction of flow between the body and the reaction chamber. This allows the fuel to flow into the reaction chamber in such a manner that it is distributed over the entire cross-sectional area of the reaction chamber.

In this connection, it is also advantageous for the body to be covered with a wax or protective coating which, for example, prevents reaction with oxygen and/or oxygen compounds. In this manner, the body is sealed and prevented from oxidation to a higher valence state after manufacture until its use in the fuel.

Finally, it is advantageous for the alloy to contain, in addition to tin, at least one of the metals copper, silver, gold, and platinum in a maximum concentration of 10%. Especially platinum gives the alloy coating a stable, non-dissolving structure because of its purely catalytic property.

It is advantageous for the alloy to be composed of 90-98% tin, 2-5% copper, 0.05-2% silver, and 0.01-5% gold. Surprisingly, gold acts as a reaction accelerator.

The percentages are usually by mass or weight, although volume-specific compositions are also common for alloys in the liquid state.

The convenient method for manufacturing an above-described body of a surface reactor is characterized in that the surface of the material on the body is activated by a reducing agent, such as sodium hydroxide solution, washed with an alcohol, and then the surface is sealed. The activated slurry produced during washing in the dipping trays is washed in alcohol and centrifuged through a fine-meshed cloth. This alcohol is then used as an additional filling for the reaction chamber. With this, the starting activity of the internal combustion engine is bridged until the chip-, wire-, or sheet metal-coated body begins to react.

In this connection, it is advantageous to subject the material to an aging process using a reducing agent, the aging process reducing the cross-sectional area, and/or to microscopically increase the surface area of the material. In the manufacturing process, during which chips are removed or the elastic modulus of the alloy is affected, the body hardens in the region of the surface. In order to remove this hardened region, the body is subjected to a so-called “aging process”. The surface is removed by repeated dipping in reducing solution. Independently of this procedure, the reduction allows the surface to be increased in the microscopic range; i.e., the specific surface area per unit area is increased.

Furthermore, it is advantageous to use and manufacture activated slurry for producing large quantities of fuel additive. The liquid fuel additive is produced as described for the reduction of the active material prior to insertion into the housings. The fuel additive is added to the tank in proportion to the tank contents.

In accordance with the present invention, the object can also be achieved by a surface reactor made of an alloy of the elements tin, copper, silver and gold, having a composition of 90-98% tin, 2-5% copper, 0.05-2% silver, and 0.01-0.2% gold, that the material is cast in a mold and machined into a continuous chip in such a manner that the obtained chip material is defonnable. This is the case for a band thickness of 0.1-0.5 mm.

In this connection, it is advantageous for the material to be made of a deformable wire, which is also braided, woven, or twisted in order to increase the surface area.

Alternatively, the material is advantageously made of a sheet metal. In order to increase the surface area, the sheet metal is rolled, punched or stamped.

With regard to a preferred embodiment, it is advantageous for the alloy to be applied as a coating to a support material that has as large a surface as possible and is made of inactive metal, plastic, or ceramic. The coating is done by electrolytic deposition on metal, electrically conductive plastic, electrically conductive ceramic, or by vapor-deposition. Possible coating methods include also spraying of cold alloy with the addition of binding agents, or spraying of molten alloy, in addition to immersion in a dipping bath.

Advantageously, the material is formed or deformed into a cylindrical, spherical, hemispherical, or tubular shape according to its housing in which it reacts with the fuel, or according to its material, and in this form is inserted in the fuel-carrying components, such as tanks, hoses, and filters.

In accordance with the present invention, in the housing in which the active material is inserted and through which the fuel flows, a filter made of wire screen and fabric is provided on the outlet side after the active material.

It is advantageous for the material to be activated and sealed by alternate dipping in sodium hydroxide solution, alcohol, and wax before it is inserted into the housing.

In a special embodiment, the specific surface area per unit area of the body is increased by blasting with blasting material, such as aluminum oxide and/or by using a reducing agent with a view to improved efficiency of the body. In this manner, the reaction surface area per unit area is also increased at the microscopic scale, thus increasing efficiency.

In connection with the design and arrangement according to the present invention, it is advantageous to use a method for initial activation of surface reactors whereby the activated slurries are filtered through a fine filter, neutralized in alcohol, and introduced as a liquid filling into the reactor housing to the surface reactor.

Also advantageous is a method for producing a liquid fuel additive whereby the activated slurries described in the patent application are filtered in a fine filter and washed in alcohol, and used, along with the alcohol carrier, as an additive for the fuel.

### BRIEF DESCRIPTION OF THE DRAWINGS

Further advantages and details of the present invention are explained in the patent claims and in the specification, and shown in the Figures. Specifically,

FIG. 1 is a sectional view of a surface reactor as an intermediate piece for a fuel line;

FIG. 2 is a sectional view of an idealized body.

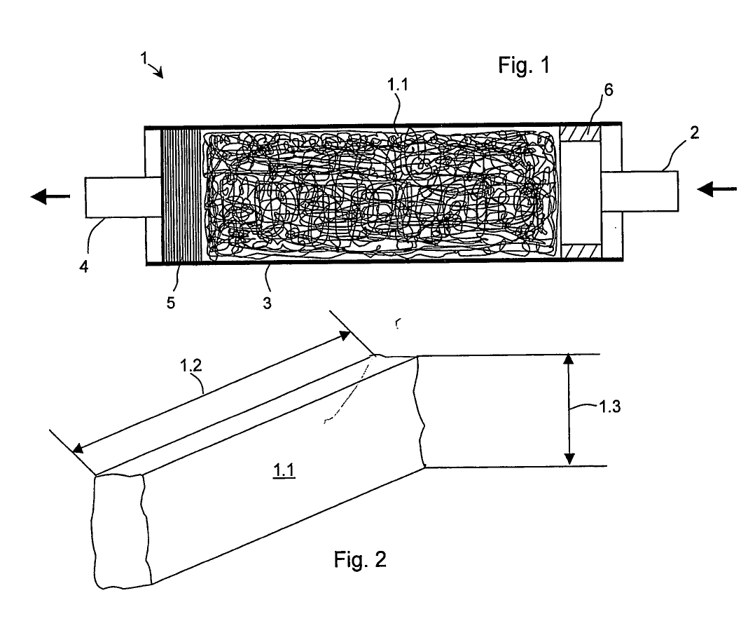

FIG. 1 shows a surface reactor 1 in a sectional view. Fuel flows through surface reactor 1 in the direction of the arrow. Body 1.1, which is made of a tin alloy, is inserted in a reaction chamber 3. Reaction chamber 3 features an inlet pipe 2 and an outlet pipe 4 for fuel. In the direction of flow, body 1.1 is spaced apart from inlet pipe 2 by a spacer ring 6. This allows the fuel to flow into reaction chamber 3 in such a manner that it is distributed over the entire cross-sectional area of reaction chamber 3.

### DETAILED DESCRIPTION

When the fuel flows through the entangled or interwoven body 1.1, the copper-tin alloy reacts with the fuel, converting unsaturated hydrocarbons in low concentration into organotins. During combustion, the organotins can be ignited very easily, and therefore act as ignition nuclei in the combustion chamber.

In order to prevent solids from entering the injection pump, a filter element 5 is provided downstream of body 1.1 before outlet pipe 4.

Reaction chamber 3 is configured as a cylindrical housing. At the end faces, the housing is double-walled in order to stably support inlet pipe 2 and outlet pipe 4 at points axially offset from each other.

In another embodiment, not shown, the cylinder of housing 3 is also double-walled. Housing 3 is screwed together and suitably sealed to allow for the insertion of body 1.1.

Body 1.1 is configured as an interwoven and tangled wad having a length of 1.2 of 100 meters and an average diameter 1.3 or width of o.5 mm.

1-30. (canceled)

31. A surface reactor for improving liquid or gaseous fuel, comprising:
a body having a length and an average diameter, the body being at least partially made of an alloy containing at least 80% tin, the alloy constituting an active material that reacts with the fuel, wherein the body is formed as one of a band, a chip, a spiral and a wire in a shape of a filament, and wherein a ratio of the length to the average diameter of the body is a value between 10 and 10⁸.

32. The surface reactor as recited in claim 31, wherein the body is exclusively composed of the alloy.

33. The surface reactor as recited in claim 31, wherein the body includes a support material coated with the alloy.

34. The surface reactor as recited in claim 33, wherein at least one of the support material and the body is formed as a chip having an average thickness of 0.1-0.9 mm and an average width of 1 to 15 mm.

35. The surface reactor as recited in claim 33, wherein at least one of the support material and the body is formed into the shape of one of a band, a spiral and a wire having an average diameter of 1-30 mm.

36. The surface reactor as recited in claim 35, wherein at least one of the support material and the body is mechanically formed from one of a cold forming and a hot forming process.

37. The surface reactor as recited in claim 31, wherein the body is one of braided, woven, twisted and interwoven so as to provide an increased surface area.

38. The surface reactor as recited in claim 31, wherein the body is formed as a band and is at least partially rolled, punched and/or stamped.

39. The surface reactor as recited in claim 33, wherein the support material includes at least one of a noble metal, an organic material and an inorganic material.

40. The surface reactor as recited in claim 33, wherein the support material is electrically conductive.

41. The surface reactor as recited in claim 33, wherein the alloy is applied to the support material by at least one of electrolysis, vapor-deposition, cold spraying, spraying, or dipping.

42. The surface reactor as recited in claim 37, further comprising a reaction chamber and wherein the body is formed according to a shape of the reaction chamber.

43. The surface reactor as recited in claim 42, wherein the shape of the reaction chamber is one of a cylindrical, a spherical and a cuboidal shape.

44. The surface reactor as recited in claim 31, wherein the body is inserted in a fuel-carrying component.

45. The surface reactor as recited in claim 44, wherein the fuel carrying component is one of a tank, a hose, and a filter housing.

46. The surface reactor as recited in claim 33, further comprising a reaction chamber, an inlet pipe and an outlet pipe (4) and a filter disposed on an outlet side of the reaction chamber, upstream of the outlet pipe and downstream of the body.

47. The surface reactor as recited in claim 46, further comprising a spacer ring disposed in the reaction chamber downstream of the inlet pipe.

48. The surface reactor as recited in claim 31, wherein the body is covered with a protective coating.

49. The surface reactor as recited in claim 48, wherein the protective coating prevents reaction with at least one of oxygen and oxygen compounds.

50. The surface reactor as recited in claim 48, wherein the protective coating includes wax.

51. The surface reactor as recited in claim 31, wherein the alloy also contains at least one of the metals copper, silver, gold, and platinum at a maximum concentration of 10%.

52. The surface reactor as recited in claim 31, wherein the alloy includes 90-98% tin, 2-5% copper, 0.05-2% silver, and 0.01-5% gold.

53. The surface reactor as recited in claim 33, wherein a surface of the alloy is activated by a reducing agent, washed with an alcohol, and sealed.

54. The surface reactor as recited in claim 53, wherein the reducing agent is a sodium hydroxide solution.

55. A method for manufacturing a surface reactor for improving liquid or gaseous fuel, the method comprising:
providing a support material;
coating the support material with an alloy so as to form a body, the alloy containing at least 80% tin and constituting an active material that reacts with the fuel, wherein the body is formed as one of a band, a chip, a spiral and a wire in a shape of a filament, and wherein a ratio of a length of the body and an average diameter of the body is a value between 10 and 10⁸.
subjecting the alloy to an aging process using a reducing agent, the aging process microscopically increasing at least one of a cross-sectional area and a surface area of the alloy.

56. The method as recited in claim 55, further comprising:
washing the material with alcohol after the reductive treatment so as to form an activated slurry;
filtering the activated slurry through a fine filter;
neutralizing the activated slurry in alcohol; and
introducing the neutralized slurry as a liquid filling into the reactor chamber.

57. The method as recited in claim 55, wherein the alloy contains the elements tin, copper, silver and gold, having a composition of 90-98% tin, 2-5% copper, 0.05-2% silver, and 0.01-0.2% gold, and further comprising casting the alloy in a mold and machining the alloy into a continuous chip in such a manner that the obtained chip material is deformable.

58. The method as recited in claim 57, wherein the chip material has a band thickness of 0.1-0.5 mm.

59. The method as recited in claim 55, wherein the body is formed as a deformable wire, and further comprising one of braiding, weaving and twisting the wire so as to increase a surface area of the alloy.

60. The method as recited in claim 55, wherein the body is formed of a sheet metal and further comprising one of rolling punching and stamping the sheet metal so as to increase a surface area of the alloy.

61. The method as recited in claim 55, wherein the support material that has a large surface and includes at least one of an inactive metal, plastic, and ceramic, and wherein the coating of the support material is performed by at least one of electrolytic deposition, vapor-deposition, spraying, and dipping.

62. The method as recited in claim 61, wherein the coating is performed by dipping in one of a cold state with bonding agents, and a liquid molten state.

63. The method as recited in claim 55, further comprising forming the body into one of a cylindrical, spherical, hemispherical, and tubular shape according to a shape of a housing, and inserting the body into a fuel-carrying component.

64. The method as recited in claim 63, wherein the fuel-carrying component includes at least one of a tank, a hose and a filter.

65. The method as recited in claim 55, further comprising providing a filter made of wire screen and fabric on an side after the coating.

66. The method as recited in claim 55, further comprising activating the alloy by alternate dipping in sodium hydroxide solution, alcohol, and wax and inserting the body into a housing.

67. The method as recited in claim 55, further comprising increasing a specific surface area per unit area of the body by blasting the body with a blasting material.

68. The method as recited in claim 65, wherein the blasting material includes at least one of aluminum oxide and a reducing agent.

69. A method for producing a liquid fuel additive comprising:
providing a support material;
coating the support material with an alloy so as to form a body, the alloy containing at least 80% tin and constituting an active material that reacts with the fuel, wherein the body is formed as one of a band, a chip, a spiral and a wire in a shape of a filament, and wherein a ratio of a length of the body and an average diameter of the body is a value between 10 and 10⁸.
subjecting the alloy to an aging process using a reducing agent, the aging process microscopically increasing at least one of a cross-sectional area and a surface area of the alloy.
washing the material with alcohol after the reductive treatment so as to form an activated slurry;
filtering the activated slurry through a fine filter;
washing the activated slurry in alcohol; and
introducing the slurry and the alcohol as an additive for fuel.
